(19) United States
(12) Patent Application Publication
(10) Pub. No.: US 2005/0261932 A1
(43) Pub. Date: Nov. 24, 2005

(54) System and method for international trade through creation of an international merchandising mart

(76) Inventor: Garald L. Bottorff, Fairfax, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 11/132,523

(22) Filed: May 19, 2005

Related U.S. Application Data
(60) Provisional application No. 60/572,324, filed on May 19, 2004.

(51) Int. Cl. G06F 17/60

(52) U.S. Cl. 705/1; 705/14; 705/28

(57) ABSTRACT

A system and method for international trade through creation of an international merchandising mart. A permanent presence is created whereby countries can lease exhibition space on along term basis. The countries in turn invite companies within their respective countries to exhibit goods and service. Product specific events are planned whereby a buyer can attend and view similar products from many countries, thereby facilitating international trade. An international trade database is created an can be accessed by retail customers desiring to find companies that produce specific products as well as information about those companies such as production capcity, qualifications, references and the like.

### CROSS REFERENCE TO RELATED APPLICATIONS

This application claims priority under 35 U.S.C. § 119(e) from provisional application No. 60/572,324, filed May 19. 2004. The 60/572,324 provisional application is incorporated by reference herein, in its entirety, for all purposes.

### FIELD OF THE INVENTION

This invention relates to the creation of a consistent International Merchandizing Mart (IMM) for Third World countries and small businesses where products and services can be brought to the world “stage” and bought and sold. More particularly, the present invention is a system(s), process(es) and method(s) for creation and maintenance of permanent (fixed) international expositions.

### BACKGROUND

Expositions of various types are a backbone of domestic and international trade. For example, international expositions abound for aircraft, (The Paris Air Show), car shows, international art expositions, clothing expositions, electronic expositions, and a host of other technologies and disciplines. All of these seek to have their goods and services “branded” on the local, regional, national, or international marketplace by virtue of exposure where those goods and services can be made known to a large number of retail customers. In this application the term “retail customer” refers to buyers from other business institutions such as retailers, store chains and the like.

While expositions of all kinds serve a tremendous marketing purpose, it is very difficult for the small business or third world company to attend multiple exhibits due to cost of travel and exhibition space. Further it is difficult for many businesses to identify where the most potential retail customers of their goods and services might be year after year. Such businesses must rely of the exhibition manager to market the exhibition to the correct group of retail customers for that business. Further, exhibits may be in different parts of the world at the same time making participation financially difficult, if not impossible However, businesses and countries are “stuck” with this type of exhibit model and wind up with individual companies and countries spending millions of dollars to try to reach a wide variety of retail customers by sending brochures, emails, media advertising, direct marketing and using a variety of other channels to get such information out to the appropriate retail customer base. In contrast, an exposition causes an individual company to spend money, but at a much lower rate to have a presence at a particular location where retail customers and other interested individuals can come to the seller of the goods and services rather than having the seller go to the target audience.

International expositions in particular can be difficult since the sellers and buyers face cultural barriers such as language, currency exchange, and trade regulations that make building “trust” almost impossible during the 2-3 days that they have together at the exhibit. It is also the case that international exhibitors hope to find teaming partners or licensees for their products so that sales can continue.

A typical international exposition involves an overall industry organization sponsoring an exposition and having that exposition take place in a fixed location. The fixed location can vary from exposition to exposition, but will typically involve a large convention center where booths and advertising space may be sold to companies that are interested in exhibiting at the particular exposition. The focus is on the individual retail customer. While this is effective on a case-by-case basis, the seller has little or no control over the promotion and management of the exhibit and once the exposition is over, the corporate presence, and consequent notoriety or advertising of that presence is over as well. Further, the seller frequently has no way to follow-up with potential retail customers unless they provide contact information. Sometimes this information is difficult to gather since there may be large numbers of people visiting a booth with and only a few sales representatives manning the booth.

Thus an exposition that takes place at, for example, the Javitz Conference Center in New York will make a big impression in the international marketplace, but when it is over, the international impression is over as well. Similarly, a convention at the Washington Convention Center will give perhaps even more of an international emphasis to goods and services of those exhibitors at the convention, but that presence and advertisement will end once the convention ends.

Where small businesses and developing countries, and their in-country companies, are concerned, this exposition wherein retail customers have access to the goods and services of those entities is extremely important yet available to very few small businesses throughout the world due to cost. For example, it is very difficult for a company that is trying to become an exporter to afford the cost associated with leasing space in a prime location such as New York, Dallas, San Francisco, or Washington D.C. to name but a few. Other costs quickly mount up for shipping their exhibits, sending sales people, the cost associated with transportation, lodging and meals, preparing marketing materials, and a whole host of other expenses that are attendant with international display of goods and services from a particular country that make participation difficult, if not impossible, for all but the most wealthy companies.

Since the market in the United States is so large and so international in nature, it is virtually imperative that any company desiring to be in the international marketplace show their goods and service at multiple exhibits in the United States. In this model the “seller is chasing the buyer”.

When a Third World company is involved, sources of funds are even scarcer than for U.S. small businesses. Small, midsize, and even large companies in the Third World are simply unable to mount a consistent exposition schedule. It is also axiomatic that in order to get one's goods “branded” in the new international marketplace, repetitive exposure is required. Thus, such small businesses around the world can barely afford (if at all) a presence at a single exposition and would certainly not be able to consistently attend and display their goods and services at multiple expositions in the United States. Thus, an even more significant barrier of entry to third world companies exists with respect to the international exposition scene than exists for U.S. small businesses.

According to the U.S. Small Business Administration, only 0.05% of U.S. small businesses export. Further, only 15% of the U.S. trade is done with the Third World which comprises ⅘ of the world's population. It is also important to note that buyers in the United States or around the world have little or no idea of the products that are available from third world countries. The U.S does approximately 80% of its foreign trade with only about 24 of the world's (200+) countries. It would be very useful for buyers in the United States to gain knowledge of the products offered by the countries with which we now do little business.

It is also the case that, while some information can be gained from the Department of State or the Department of Commerce, dealing with foreign countries and their respective embassies for import and export information, or over the internet, does not give first hand information from those involved. This activity furthers the “trust’ necessary to pursue the deal.

What would be particularly useful, therefore, would be a system(s), process(es) and method(s) for conducting and maintaining a permanent exposition of goods and services from non-trading (developing) countries and small businesses all over the world. Such a model would dramatically decrease the expense associated with displaying the goods and services available from those countries, and provide enhanced information concerning the products and procedures of buying and selling between countries.

### SUMMARY

The present invention comprises a system(s), process (es) and methods so that the countries (third world-non trading countries) will lease permanent space (office and fixes exhibit space) and participate in a series of ongoing exhibits by leasing temporary exhibit space promoted by the management not to retail customers, but to the wholesale and retail buying organizations that buy in lots (1000's of units) to be resold to the retail stores. The present invention represents a “One Stop Shop” that provides the “stage” and the entire infrastructure, to include bringing the buyer and seller together, necessary to make these historically non-trading entries successful in the world marketplace. For purposes of this application the entity described is referred to as an “International Mechanizing Mart” (IMM). In general, but not as a limitation, the IMM could be closed to individual customers but open to the retail customers (i.e. buyer for stores and retail chains). The IMM of the present invention avoids the typical situation of “buyers are chasing the sellers” and vice versa, by the establishment of a critical mass of products at a single location from a variety of sources that allows retail customers to compare pricing, quality, new mechanizing, partnerships, and licensing agreements in a convenient fashion without the retail customer having to travel to multiple locations.

It is therefore an aspect of the present invention to create an IMM with a focus on economically assisting small businesses, third world countries and companies and other non-trading entities in international trading.

It is another aspect of the present invention to establish country-specific exhibition areas where the business and culture of a particular country can be represented on a consistent basis.

It is yet another aspect of the present invention to provide country-specific leases of space to permit the products and services of a given country to be exhibited.

It is yet another aspect of the present invention to create the infrastructure within the management structure of the IMM to provide “one-stop” marketing and sales support for both the countries participating as well as the visiting companies subleasing space from their country for exhibits that correspond to their product line to efficiently conduct international trading.

It is yet another aspect of the present invention to maximize the exposure of goods and services of companies, in particular small businesses and Third World countries, through hosting and promoting international expositions by product line, (i.e. leather goods, medical equipment, wines of the world, etc).

It is a further aspect of the present invention to solicit input for product-specific exhibits from participating countries and companies where similar products and associated exhibits are coordinated thought the year.

It is still another aspect of the present invention to create multi-country participation in the IMM to enhance the international trading presence of countries that have not had significant international trading experience.

It is a further aspect of the present invention to create a fixed exposition center, which may be located at different major sites, where goods and services can be consistently marketed over extended periods of time.

It is a further aspect of the present invention to allow a consistent display of goods and services from a variety of companies where the company subleases the exhibit space from their own government.

It is a further aspect of the present invention to reduce the overall cost to individual companies for participation in international expositions.

It is a further aspect of the present invention to showcase products and services from individual companies when their country elects to participate in the permanent international exposition.

It is still another aspect of the present invention to conduct product-specific promotional events in conjunction with a more permanent international exposition.

It is a further aspect of the present invention to conduct cultural and educational events associated with countries in the context of an IMM to further the understanding of diversity and the role that international trade in everyday life.

It is another aspect of the present invention to maintain a trade information center in conjunction with the IMM to facilitate responses to questions regarding the importing and exporting of goods and services

It is another aspect of the present invention, to allow exhibiting countries to build out their space in an architecture correct setting in keeping with their countries' design and cultural heritage.

It is another aspect of the present invention, to operate an IMM such that retail customers can have easy access to sellers, and so that the public can participate as exhibition attendees, thereby becoming acquainted with the goods and services of countries and companies.

These and other aspects of the present invention will become apparent to those skilled in the art upon review of the summary and detailed description that follows.

As noted above, the present invention comprises a system (s), process(es), and method(s) for the conduct of international expositions. The goal of the present invention is to create for countries the ability to efficiently and effectively advertise and showcase goods and services offered by those countries and the companies they represent. A consistent physical location is established so that a continuous presence for a plurality of exhibition spaces, each of which is assigned to a particular country is established. For purposes of this application, this facility is called an International Merchandising Mart (IMM). This IMM is located in an area of commercial importance. Several IMM's may be present in a country such as the United States where multiple commercial centers are located. Further, a plurality of IMM's may give additional penetration into the marketplace of a country where the IMM's may be located.

It is important to note however that the present invention is not limited to the U.S. market. Other IMM's may also be established in other non-trading countries such as the India, Chile, Bulgaria, China, and other locations as required to penetrate those markets as well.

The IMM comprises exhibition space for a plurality of participants. The participants in the IMM, under the present invention, would likely be individual countries although this is not meant as a limitation. For economies of scale, several countries might band together to create a regional presence at an IMM rather than have each country bear the cost alone for the desired exhibition space. Likewise, groups of trade associations/unions might wish to showcase their capabilities and services. Those individual countries would lease space in the IMM on an ongoing basis. In other words, rather than simply renting an exhibition space (which may be a booth, an office or some other area where exhibition of goods and services can occur) for a brief period of time as in a single exhibitor or conference, individual countries would lease permanent exhibition and office space which could be of a variety of different sizes. Also available would be permanent exhibit space for longer periods of time, for example a period of six months, one year, two years, etc. The objective of the longer term exhibition space rental is to have a consistent and reasonably constant presence of that particular country's goods and services available for the retail customers to get a sense of the skill of the country's craftsmen and to showcase the country to the general public.

As individual countries lease their respective temporary exhibition space for each exhibit event, they could advertise that exhibition space in their home country. Part of that advertisement would be to offer the temporary exhibition space to individual companies within that country for each promotional event. Alternatively, the country can simply select goods and services which it wishes to showcase at the IMM to highlight the unique nature and talents of its citizens. Management of the individual country exhibition space is in the control of the particular country and therefore subject to economic priorities of that country.

Individual companies can sign up for some portion of the temporary exhibition space of a particular country at the IMM and thereby showcase their goods and services and provide appropriate literate and informational material to those manning the exhibition space at the IMM at a very reasonable cost. They could also have a say in the promotion of each exhibit since their country is a permanent member of the organization.

The IMM exhibition space for a particular country would be manned by individuals from that country in conjunction with commercial representatives (if desired), or from the companies that are exhibiting goods at the exposition space or under contract to management. In this fashion, the companies within the country can have affordable exhibition space in, for example, the United States without having to expend huge amounts of money in order to send people, establish their own exhibition presence, and other overhead costs associated with international expositions.

Infrastructure support will be packaged so that the knowledge of the product and or service is all that is necessary for the sale. These include (partial list): a trade information and service center, translation services, banking services, shipping/storage services, conference facilities, training facilities, legal and consulting services. Each company exhibiting will be tied into the computer services so that they can continue to sell after the exhibit is over.

There are numerous advantages to the system and method of the present invention. By having the IMM and having space leased on a longer term basis by the individual country, a more effective cost sharing of international expositions can be accomplished. The cost of leasing an exhibition space on a longer term basis is likely to be more realistic for a country than it would be for an individual small business budget within that country. Further, since individual countries frequently have budgets specifically to allow for the promotion of commerce regarding goods and services from that country, the country would more likely be a participant in such an IMM that has a permanent presence than would an individual company that could scarcely afford to have that presence on a day-by-day basis over a long period of time. Further, a country can lease on a long term basis exhibit space in the temporary exhibit area to realize the cheapest cost to their member companies.

A further advantage of the present invention to international commerce is that the IMM would, from time to time, have product-specific expositions in the IMM. For example, rather than have leather goods displayed on a random schedule at different exhibition spaces within the IMM, the IMM can sponsor a leather goods exhibition for a specific period of time. Individual countries that become a part of the IMM would then solicit participation from those industries and companies within their own country that specialize in leather goods to display those goods at the IMM at the appointed time.

By management hosting a product-specific exhibition period at the IMM, advertisement can be distributed to the market involved, for example leather goods buyers within the United States (250,000 retail buying organizations in the U.S. alone), and those individuals would more likely come to the IMM for that particular exposition since they would be guaranteed to view a wide variety of leather goods products from a variety of different countries and companies in a relatively short period of time. This is particularly effective for leather goods buyers since they do not have to go to many different countries and many different expositions in order to possibly find leather goods displayed there. They would be guaranteed that leather goods would be displayed at the IMM by all of the countries present at the particular point in time. Thus a tremendous amount of efficiency not only for individual countries but for buyers in the United States and around the world.

In summary, the present invention comprises a system and method for the creation and administration of international trade through the creation of an international merchandising mart. An exposition management entity such as a corporation or association creates a permanent facility having exposition resources such as communications, advertising and marketing, export data and databases. The exposition management entity creates contractual relationships with countries desiring to participate in the international trade market.

The exposition management entity creates an inventory of events that are to be staged throughout a period of time (normally a year of two). These events may be product-specific or service-specific events. Each country can participate in each event to the extent that it has products or services relating to the event. The country may then notify businesses in their respective countries of the specific opportunity allowing them to participate by showing their products and services.

A “target list” comprising individuals and retail customers is created with information noting the specific products of interest to that retail customer. Information on the specific events is then sent to those targets having the appropriate interest.

Administrative information on the participating countries and points of contact are maintained.

Prior to specific events, advertising from the country and businesses from that country are solicited and stored. This information is made available to retail customers by pushing the information to them or by allowing those retail customers to access the trade database having that information.

The exposition space comprises a permanent facility having configurable exhibition areas. This allows individual countries to build out their space in a culturally identifying manner. Countries participating in the IMM are expected to engage in long term leases of space so that a constant is presence is available to retail customers.

An export database accessible by the country and retail customers is also present and is adapted to respond to inquiries relating to companies having particular characteristics in a particular country. Company capabilities such as types of products, pricing of products, production schedules for the products, ISO qualifications, references, and services are all stored and available for query. In this way, retail customers can establish relationships with producers in foreign countries.

### BRIEF DESCRIPTION OF FIGURES

FIG. 1 illustrates the overall structure of the present invention.

FIG. 2 illustrates the IMM interaction with individual countries and others.

FIG. 3 illustrates the flow of establishing the international exposition of the present invention.

FIG. 4 illustrates the data management structure associated with the IMM.

### DETAILED DESCRIPTION

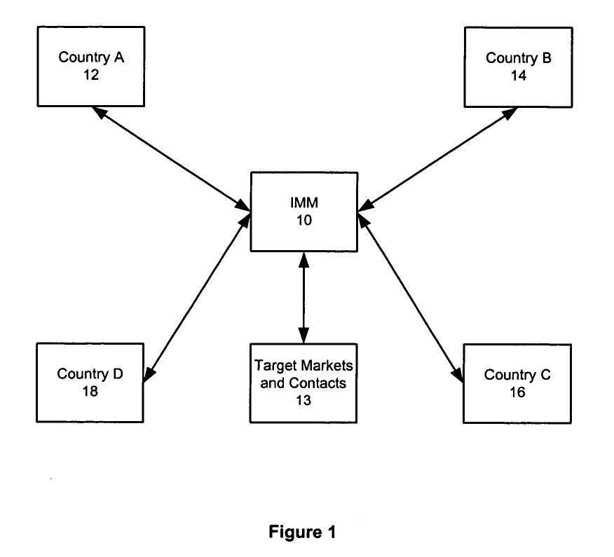

Referring first to FIG. 1, the overall structure of the exposition of the present invention is illustrated. The international merchandising (IMM) 10 comprises a fixed exhibition center and establishes legal relationships for the lease or for permanent office and exhibition space with countries 12, 14, 16, and 18. These countries rent exhibition space from the IMM 10 and are thereby guaranteed a consistent exhibition space. The rental fee that is charged covers not only the rent, but also covers a full range of marketing and sales services to include translation, capital, education through distance learning, banking, consulting services, etc. A “One Stop Shop” of infrastructures to promote each and every country and company's product with emphases on teaming and licensing agreements, etc.

The IMM in turn provides a wide variety of services to the individual countries. For example, IMM 10 will conduct all of the advertising associated with the IMM to the various markets that the individual countries desire to penetrate and provides advertising and event information to various targeted markets and contacts 13. The IMM also solicits contact information and event input from those market contacts 13 in order to have the most relevant commercial events and so that a database of contacts, the interest areas of those contacts, and communication information is present in the database. The IMM 10 will organize industry specific exhibitions and advertise those to the target markets and industry contacts 13. Such industry contacts are, without limitation, retail customers, corporate entities and other organizations with a desire for information on international trade. The IMM 10 will keep a consistent schedule and notify the individual participating countries of the specific exhibitions and, of greatest importance, the IMM will establish and maintain a fixed continual exposition presence in which individual countries can participate. In addition, the industry contacts 13 can interact with the IMM to engage in searching for business partners in foreign countries. Partner searches allow retail customers, for example, to query a database (explained more fully below) for companies in specific countries having the capability to produce specific products, of specific a quality on a specific schedule.

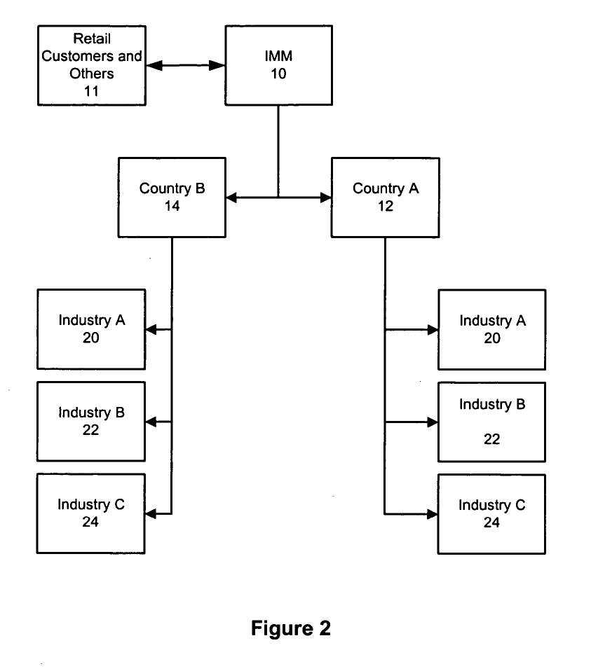

Referring next to FIG. 2, the IMM interaction with individual countries and others is illustrated. IMM 10 rents space in the fixed exposition center to countries A and B, 12, 14. Country A 12, for example, will then notify industry A 20, industry B 22 and industry C 24 in their home countries of the availability of the exhibition space and of the schedule of exhibitions that will exist during the course of a year. Those industries can then respond to country A 12 with goods, explanation of those goods, or services and advertising and promotional literature and/or personnel to man the exhibition space during the appropriate time. As part of this service the IMM maintains a database of relevant information such as events, country information, industrial information in the respective countries and other information to enhance international trade.

Similarly, country B 14 when notified by IMM 10 of the particular schedule of exhibitions can contact its corresponding industries A, B, and C (20, 22, 24), that exhibitions will take place. Those industries can then provide goods, explanations of services, personnel, and advertising and promotional literature to the country for display in the individual countries exhibition space.

In an alternative embodiment, industries in individual countries can access an IMM web site and note the schedule planned for various exhibitions. Industries can then contact their country representatives seeking to participate in the IMM at the appropriate event date(s). Similarly retail customers and others 11 who have qualified to access the IMM can view the IMM database for events of interest and, via the web site, contact industries within the countries who might be exhibiting at any given event.

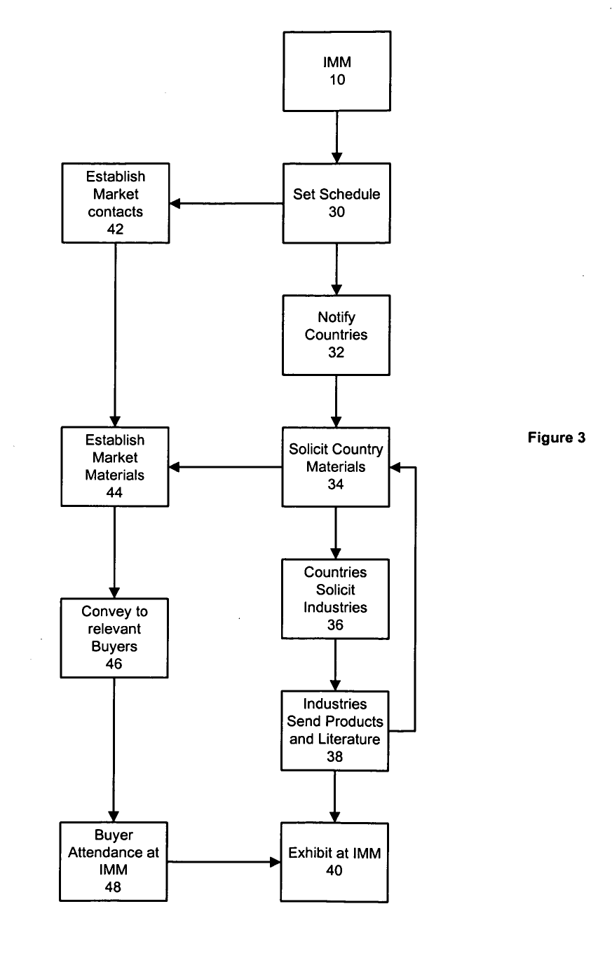

Referring now to FIG. 3, the flow of establishing a particular exhibition of the IMM is illustrated. IMM 10, sets a schedule of industry specific exhibitions 30 and conveys that information to the individual members of the IMM 32. With that notification of schedule, IMM 10 solicits country materials from the individual countries that participate in the IMM 34.

Upon receipt of the schedule of exhibitions, individual countries solicit the industries in their country 36 for products, services, and literature. Those contacted industries, and the respective companies in that industry send products and literature 38 to the member country. Those materials and literature are then used by the officials of the member country (or participating corporate representatives) to exhibit at the IMM 40. Of course those skilled in the art will understand that these materials will be submitted in hard copy or in electronic form over networks known in the art.

As part of the activity wherein the IMM sets the schedule for exhibitions 30, the IMM establishes market contacts with the relevant buyers in the marketplace 42. The IMM maintains a database of market contacts for a variety of markets and industries. For example, and as noted above, if the IMM decides to have a leather goods exhibition, it will notify appropriate buyers in the leather goods industry that an exhibition will take place at the IMM during a particular range of dates. The IMM will then establish marketing materials 44 that generally describe the specific exhibition that is going to be given and will use the industry specific products and literature material from the individual countries to establish those marketing materials. Thus the marketing materials 44 established by the IMM will contain highlights from the individual countries regarding the industries and products that are to be exhibited on the specific dates advertised. The IMM will then convey that marketing material to relevant buyers 46 (or other interested parties) so that the buyers know that they can come to a specific location of the IMM and see the leather goods from many different countries exhibited there. The buyers can then attend the exhibition at the IMM 48 and thereby minimize the costs associated with finding out what other countries and companies within those countries have in the way of leather goods.

Of course this example is but one industry. Many different industries such as electronics, tourism, and other valuable industries can have their own separate dates for specific exhibitions at the IMM.

In addition to specific temporary exhibitions, however, countries can choose to exhibit any goods or services they desire at other times and even during other industry specific periods within their permanent leased exhibit spaces. In short, there would be no restriction on the individual country and how it exhibits goods and services to the public that attends the IMM.

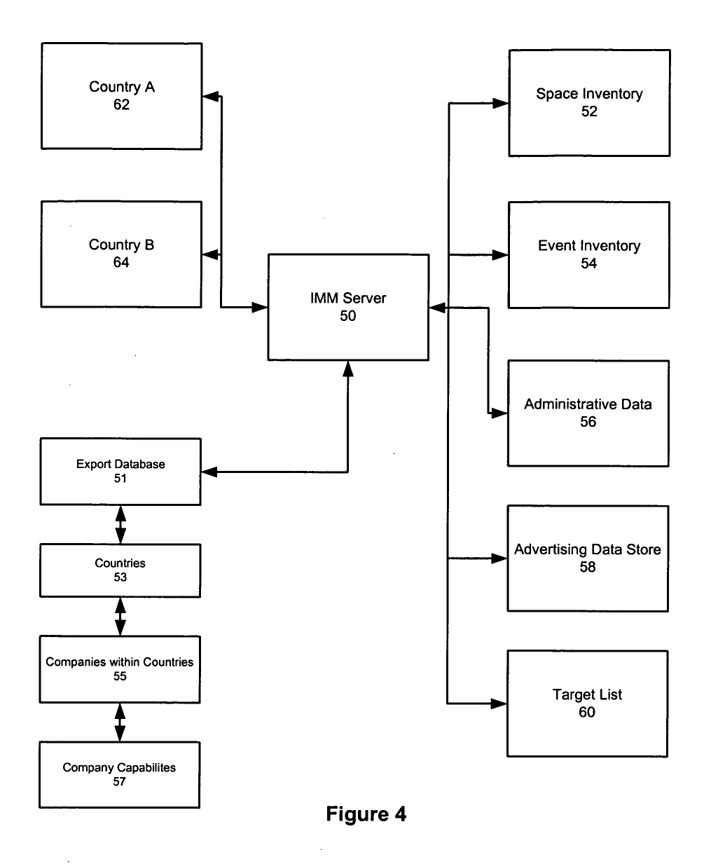

The interaction of the IMM with Countries and industry groups noted in FIG. 3 is accomplished by the embodiment illustrated in FIG. 4. The IMM system comprises a server 50 and a number of data stores associated with offering of services for exhibitions and members of the IMM. The IMM system is accessible by the Internet or other electronic means and permits countries to establish a presence at a fixed location, and supports those countries in their quest to advertise their goods and serves. The IMM system also allows its members to access information online that is relevant to commercial goals of the members. For example, and without limitation, certain members may desire to establish business relationships with companies in selected countries. The information in the IMM, as more fully set forth below, facilitates this interaction.

Administrative Data Store 56 comprises electronic information relating to points of contact and contractual relationships that exist with member countries, as well as agreements with various countries 62, 64 that are participants in the IMM. This information further comprises factors and characteristics of each country such as products available, types of exhibits desired, space requirements and contact points. Any member country is free to change its administrative data and profile of goods and services at anytime. This data will automatically be populated into the Administrative Data store and used for sorting purposes as noted below.

Export database 51 stores information on company capabilities 57 associated with a company 55 with the country of residence 53 of those companies. This information is hierarchically stored and associated with a particular country. Thus a retail customer that has access to the IMM can investigate the products and services offered by 1000's of small businesses in each country so that the retail customer can determine if a product of interest is available from a company within a given country, and can compare price, production capabilities and delivery dates, quality, etc. (i.e. qualification factors of a company).

Whenever a particular event is planned, it is stored in an Event Data Store 54. The event data will comprise characteristics of the event, such as products desired, dates, and other data relating to cost as well as other data germane to the potential exhibitor. This information is sorted against the Administrative Data Store 56 to determine which countries will be likely participants. For example, a clothing exhibit notice will go to those countries that have expressed an interest in exhibiting clothing from their country. Notices will not go to countries that have not expressed an interest.

Using the Administrative Data Store 56, notices will be sent to the point of contact (or multiple points of contact) in each country notifying of the exhibit dates. Thereafter, the country can respond to the notice, notify industries and companies in their respective countries, and participate in the exhibition.

The Space Inventory Store 52 keeps records of which countries have participated in the IMM by reserving space and notes when space reservations are current and when they come up for renewal. The Space Inventory Store 52 causes the IMM server to send notices to countries concerning their respective space reservations and renewal information. It will also take reservations for space from new member countries of the IMM. Whenever space becomes available, the IMM server polls the Space Inventory Store 52 for available space and causes notices to be sent to member countries as well as to countries that have expressed an interest in exhibiting or which are on a waiting list to exhibit.

An Advertising Data Store 58 is part of the IMM system. Whenever a country becomes a member of the IMM, that country sends advertising material that is used by the IMM server to advertise the goods and services of the member country. As that advertising is received, it is placed in the Advertising Data Store 58 for use by the IMM server in preparing and submitting advertising concerning upcoming exhibitions.

The IMM system also comprises a “Target List” 60 comprising persons and organizations interested in specific goods and services. For example, Company X in the U.S. may be interested in shoes while Company Y may be interested in electronics. Whenever a solicitation for member countries goes out for an exhibition relating to clothing and where shoes will be a prominent exhibit from member countries, the IMM server will cause an advertising message to go to the companies or persons on the Target List that have expressed an interest in shoes. Such a notice will not go out to the entities that are interested in electronics. In this way the IMM can reasonably guarantee a country that the right audience for the exhibition will be present.

The Target List 60 is created by the IMM system through questionnaires to the companies or those expressing interest in exhibitions by the IMM. In this manner a profile of potential targets is created and used for sorting of outgoing advertising messages. Additionally, those entities that are on the Target List can submit bids for goods and services of companies resident in the countries that are members of the IMM. This is accomplished by the MM by putting the Target entities in contact with the appropriate person noted in the country administrative data who can then introduce buyers with specific companies in the member country. In this way thousands of buyers and buying organizations in the U.S., for example, can potentially obtain offers of goods and services from those countries that are members of the IMM.

Thus using the IMM system, space can be reserved by countries for exhibition of goods and services. Country profiles can be created, stored and updated so that countries can be notified of specific events and exhibitions. Countries can provide appropriate advertising that can be disseminated to interested parties. Those interested in visiting exhibitions can create a profile so that notifications can be sent to interested parties.

In summary, the IMM system provides for a constant country presence at a fixed exhibition location, manages the inventory of space for exhibition, provides management services for countries so that exhibition can be specific to products and services, and provides a way for interested purchasers to visit a single location to see goods and services offered by a participating country (ies).

A system and method for the conduct of expositions in the international marketplace has now been illustrated. It will be apparent by those skilled in the art that other fixed types of expositions where countries and companies can rely on a continual presence in the marketplace will be possible without the parting from the scope of the invention as disclosed. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

1. A system for the creation and administering international trade through the creation of an international merchandising mart comprising;
an exposition management entity having exposition resources;
the exposition management entity having a contractually specified interface with a country;
an event inventory established by the exposition management entity;
the event inventory comprising management information relating to an event in which the country can participate;
a target list specific to the event in the event inventory established by the exposition management entity;
an administrative datastore accessible by the exposition management entity;
the administrative datastore comprising administrative information relating to the country;
an advertising datastore established by the exposition management entity and accessible to the country whereby the country submits advertising material specific to the country and specific to the event in the event inventory; and
a notification facility whereby the event from the event inventory is submitted to the target list together with the advertising material from the country specific to the event.

2. The system of claim 1 wherein the exposition resources comprise exposition space.

3. The system of claim 2 wherein the exposition space comprises a permanent facility.

4. The system of claim 2 wherein the exposition space comprises a configurable exhibit space.

5. The system of claim 4 wherein the configurable exhibit space is contractually assigned to the country.

6. The system of claim 1 wherein the contractually specified interface comprises a long term lease of the exposition resources to the country.

7. The system of claim 6 wherein the contractually specified interface further permits the country to sublease the exposition resources to a designated company from the country.

8. The system claim 1 wherein the event inventory comprises product-specific events.

9. The system of claim 1 wherein the event inventory comprises service-specific events.

10. The system of claim 1 wherein the target list comprises retail customers associated with a specific product.

11. The system of claim 1 wherein the target list comprises retail customers associated with the country.

12. The system of claim 1 wherein the administrative datastore comprises information associated with the country.

13. The system of claim 12 wherein the information associated with the country comprises contact information for the country, contractual documents associated with the country, products and services of the country, and export information associated with the country.

14. The system of claim 1 wherein the advertising datastore comprises advertising that the country desires to be communicated to the target list.

15. The system of claim 1 wherein the notification facility comprises solicitation component whereby the exposition management entity solicits interest from a target regarding the country, products, and services.

16. A method for creation and administering of international trade through the creation of an international merchandising mart comprising:
establishing a fixed exposition facility having exposition resources;
establishing a contractual relationship with a country relating to the exposition resources;
establishing an event inventory associated with the exposition resources comprising events in which the country can participate;
establishing a target list of entities interested in events in the event inventory;
establishing administrative data associated with the country;
soliciting advertising content from the country relating to the event inventory; and
notifying the target list of events in the event inventory.

17. The method for creation and administering international expositions of claim 16 wherein establishing a fixed exposition facility having exposition resources comprises creating and maintaining on a consistent basis, a permanent exhibition space for the display of goods and services from traditionally non-trading countries.

18. The method for creation and administering international expositions of claim 16 wherein establishing a fixed exposition facility comprises establishing a physical facility with configurable exhibition space.

19. The method for creation and administering international expositions of claim 18 further comprising assigning a portion of the configurable exhibition space to the country.

20. The method for creation and administering international expositions of claim 16 wherein establishing a contractual relationship with a country relating to the exposition resources comprises establishing a long term lease of the exposition resources to the country.

21. The method of claim 20 wherein establishing a contractual relationship with a country relating to the exposition resources comprises establishing a long term lease of the exposition resources to the country.

22. The system of claim 10 further comprising an export database accessible by the country, the exposition management entity and the retail customer, the export database adapted to respond to inquiries relating to companies having particular characteristics in a particular country.

23. The system of claim 22 wherein company capabilities are taken from the group consisting of products, pricing of products, production schedules for the products, ISO qualifications, references, and services.

24. The method of claim 20 wherein the contractual relationship with a country further permits the country to sublease the exposition resources to a designated company from the country.

25. The method of claim 16 wherein the event inventory comprises product-specific events.

26. The method of claim 16 wherein the event inventory comprises service-specific events.

27. The method of claim 16 wherein the target list comprises retail customers associated with a specific product.

28. The method of claim 16 wherein the target list comprises retail customers associated with the country.

29. The method of claim 16 wherein the administrative datastore comprises information associated with the country.

30. The system of claim 16 wherein the advertising content comprises advertising that the country desires to be communicated to the target list.
